(19) United States
(12) Patent Application Publication
(10) Pub. No.: US 2010/0086262 A1
(43) Pub. Date: Apr. 8, 2010

(54) BI-DIRECTIONAL OPTICAL MODULE WITH PRECISELY ADJUSTED WDM FILTER

(75) Inventors: Toshiaki KIHARA, Yokohama-shi (JP); Hiromi NAKANISHI, Yokohama-shi (JP)

Correspondence Address: VENABLE LLP, P.O. BOX 34385, WASHINGTON, DC, 20043-9998, US

(73) Assignee: Sumitomo Electric Industries, Ltd., Osaka-shi (JP)

(21) Appl. No.: 12/575,051

(22) Filed: Oct. 7, 2009

(30) Foreign Application Priority Data
Oct. 8, 2008 (JP) 2008-262083

(51) Int. Cl. G02B 6/36

(52) U.S. Cl. 385/89

(57) ABSTRACT

A bi-directional optical module with an arrangement to install WDM filters easily and precisely is disclosed. The optical module of the invention provides two or more optical devices, a filter unit installed with one or more WDM filters, and a coupling unit. One end of the filter unit assembles the coupling unit, while the other end thereof assembled a specific optical device. Rest optical devices are assembled with the filter unit such that their optical axes are perpendicular to the axis connecting the coupling unit with the specific optical device. The WDM filters are set on the inner of the filter bore such that the angle thereof is adjusted by rotating it as coming the edges of the WDM filter in contact with the inner wall.

### CROSS REFERENCE TO RELATED APPLICATIONS

This application is related to patent application Ser. No. 12/419, 522 filed Apr. 7, 2009, which is hereby incorporated by reference.

### BACKGROUND OF THE INVENTION

1. Field of the Invention

The present invention relates to an optical module, in particular, the invention relates to a bi-directional optical module that has an optical transmitting function and an optical receiving function for the single optical fiber.

2. Related Prior Art

The U.S. Pat. No. 7,364,373, has disclosed a bi-directional optical module with a function to transmit light with the wavelength of 1.31 μm and to receive light with the wavelength of 1.48 or 1.55 μm. FIGS. 13 and 14 are perspective views of the optical modules, 100 and 100A, disclosed in the prior patent above, where the filter units, 100A and 130A, are broken to show the inner arrangement thereof.

The optical module 100A includes the optical transmitting device 110 with a semiconductor laser diode, the optical receiving device 120 with a semiconductor photodiode, and the filter unit 130A. Each of optical device, 110 and 120, has a co-axial package and is assembled with the filter unit 130A with the cylindrical body. One end of the filter unit 130A is assembled with the coupling unit 140 generally including an optical sleeve, or a pig-tail unit when the bi-directional module is to be coupled with the external apparatus with the pig-tail fiber.

Within the filter unit is installed with a wavelength division multiplexing (hereafter denoted as WDM) filter 312 and a cut filter 134. The light emitted from the first optical device 110 transmits the WDM filter 132 after being concentrated by the lens 112 set at the top of the device 110 and optically couples with the optical fiber in the coupling unit 140. While, the light provided from the optical fiber in the coupling unit 140 is reflected by the WDM filter 132 and heads the second optical device 120 which is assembled in the side wall of the filter unit 130A. The second optical device 120 also provides the lens assembled in the top thereof, although which is not illustrated in FIG. 13, and the light heading the second optical device 120 after it is reflected by the WDM filter 132 is concentrated by this lens to enter the photodiode in the device.

The filter unit 130A provides a plurality of bores, 130a and 130c to 130d, from one end thereof to the other end. The light emitted from the first optical device 110 passes these bores to head the WDM filter 132. The outer side surface of the filter unit 130A provides a slope 130f on which the WDM filter 132 is mounted. The slope 130f has an angle of substantially 45° against an axis connecting the optical axis of the optical device 110 and that of the optical fiber in the coupling unit 140, because the light coming from the fiber is necessary to be coupled with the optical device 120 and the light emitted from the device 110 is also necessary to be coupled with the optical fiber.

FIG. 14 shows another conventional optical module 100B where the module provides the third optical device 160, the second WDM filter 136 and the second cut filter 138 in addition to the elements provided in the optical module 100A shown in FIG. 13. The light emitted from the first optical device 110 and that provided from the optical fiber in the coupling unit 140 each ahs the axis same as those described above, while, a portion of the light provided from the optical fiber in the coupling unit 140 is reflected by the second WDM filter 136 and heads to the third optical device 160. The filter unit 130B provides another slope 130f to install the second WDM filter 136 thereon, which makes an angle of substantially 45° with respect to the axis connecting the first optical device 120 with the optical fiber in the coupling unit 140.

When the WDM filters, 132 and 136, are made of multi-layered films; the incident angle of the light influences the performance of the filters, that is, the wavelength cut-off characteristic depends on the incident angle of the light. Because the WDM filter, 132 or 136, is requested to transmit entirely the light with the wavelength of 1.31 μm, but to reflect entirely the light with the wavelength of 1.48 or 1.55 μm; the incident angle of the light for the WDM filter, 132 or 136, is necessary to be precisely adjusted. Therefore, the physical arrangement of the slope on which the WDM filter, 132 or 136, is mounted, is precisely processed by, for example, a milling cutter, which raises the process cost of the optical module, 100A or 100B.

### SUMMARY OF THE INVENTION

One aspect of the present invention relates to a bi-directional optical module that processes the first and second optical signals each having first and second wavelengths different from each other with respect to single fiber. The bi-directional module includes at least first and second optical devices, a first WDM filter and a filter unit for installing the first WDM filter. The first and second optical devices process the first and second optical signals, respectively. The first WDM filter transmits the first optical signal, while, it reflects the second optical signal. The optical device according to the present invention has a feature that the filter unit provides a filter bore that has an inner wall portion of a curved shape with a preset curvature, and the first WDM filter comes in contact with the inner wall portion by two edges.

The filter unit may further provide the first and second bores each passing the first and second optical signals, respectively. The first bore crosses the second bore, and, in the present inventions, the filter bore crosses a point where the first bore crosses the second bore. These first and second bores, and filter bore may be easily formed by drilling for a metal based filter unit; accordingly, the process cost of the present optical module may be reduced.

Moreover, the optical module according to the present invention may further provide a third optical device, a third bore in the filter unit and a second WDM filter. The third optical device processes a third optical signal, and third bore passes this third optical signal and crosses the first bore. The filter bore crosses two points where the first bore crosses the second bore and the first bore crosses the third bore, and provides anther inner wall portion of a curved shape with a preset curvature. The second WDM filter comes in contact with the other inner wall portion by at least two edges thereof.

The filter bore, in this case, may have an expanded circular shape with two semicircular portions and two straight portions each connecting the semicircular portions. The first WDM filter may be set on one of the semicircular portions, while, the second WDM filter may beset on the other of semicircular portions. In the present invention, these first to third bores and the filter bore may be easily processed by drilling the filter unit, which may reduce the process cost.

Another aspect of the present invention relates to a method to assemble a bi-directional optical module that provides at least two optical device each processing optical signal with a specific wavelength different from each other, a WDM filter that transmits one of optical signals and reflects the other of optical signals, and a filter unit that installs the WDM filter and assembles the first and second optical devices therewith. The method comprises steps of: (a) forming first and second bores in the filter unit each passing the first and second optical signals, the first bore crossing the second bore in substantially right angle; (b) forming a filter bore in the filter unit, the filter bore having an inner wall portion with a curvature and crossing a point where the first bore crosses the second bore; (c) adjusting the angle of the WDM filter in the filter bore as abutting the WDM filter against the inner wall portion by at least two edges thereof; and (d) fixing the WDM filter to the inner wall portion by irradiating the adhesive provided on the two edges of the WDM filter with ultraviolet rays from at least on of the first and second bores. In the method of the present invention, the formation of the all bores may be carried out by drilling the filter unit

### BRIEF DESCRIPTION OF DRAWINGS

The invention may be more completely understood in consideration of the following detailed description of various embodiments of the invention in connection with the accompanying drawings, in which:

FIG. 1 is an appearance of the bi-directional optical device providing the optical module according to an embodiment of the present invention;

FIG. 2 is a perspective view of the optical module of the present invention;

FIG. 3 is a perspective view of the optical module, in which the filter unit is broken to show the cross section thereof;

FIG. 4 is a perspective view of the filter unit formed by drilling a pillared metal member for a plurality of bores;

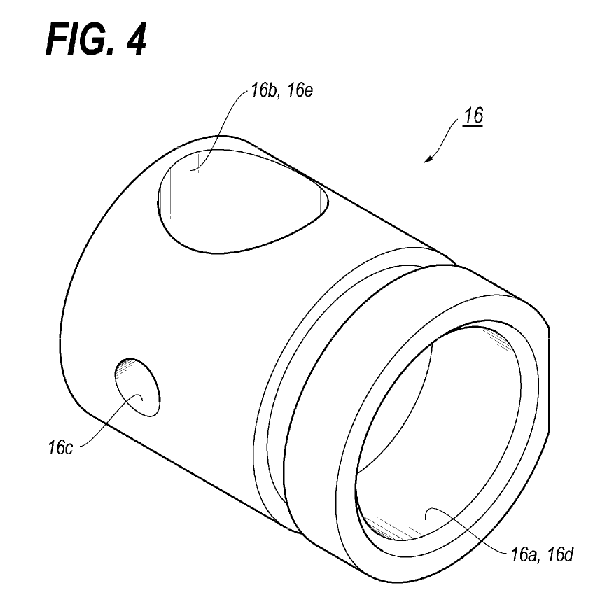

FIG. 5 is a perspective view of a tool for setting the WDM filter to a preset position in the filter bore of the filter unit;

FIG. 6 is a perspective view showing a process to set the WDM filter in the filter bore;

FIG. 7 is a cross section to show a process for adjusting the angle of the WDM filter with respect to the optical axis of respective optical devices;

FIG. 8 is a cross section to show a process for setting and fixing the cut filter in the preset position in the bore;

FIG. 9 is a perspective view of an optical module according to the second embodiment of the present invention;

FIG. 10 is a perspective view of the optical module shown in FIG. 9, in which the filter unit is broken to show the inner arrangement of the WDM filters;

FIG. 11 is a cross section of the filter unit shown in FIGS. 9 and 10;

FIG. 12 is a modification of the filter bore for the optical module shown in FIGS. 9 and 10;

FIG. 13 is a perspective view of a conventional optical module, in which the filter unit is broken to show the arrangement of the WDM filter in the filter unit; and

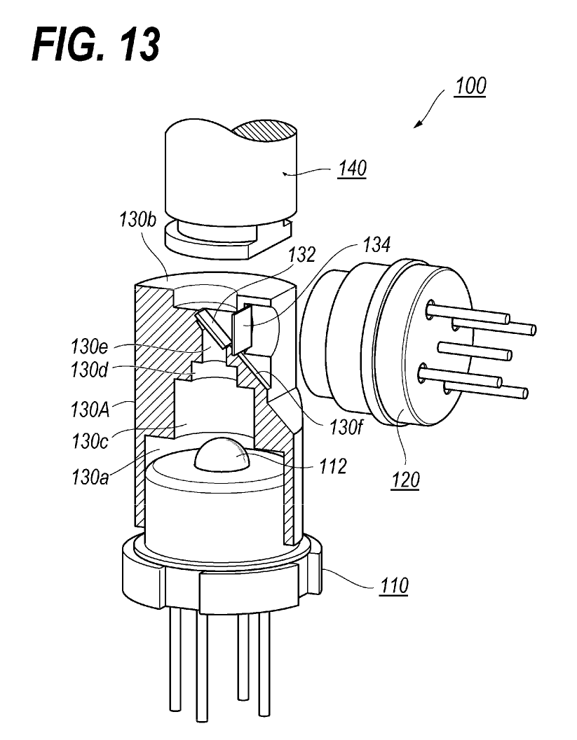

FIG. 14 is an exploded view of the conventional optical module with tree optical devices, in which the filter unit is broken to show the inner arrangement thereof.

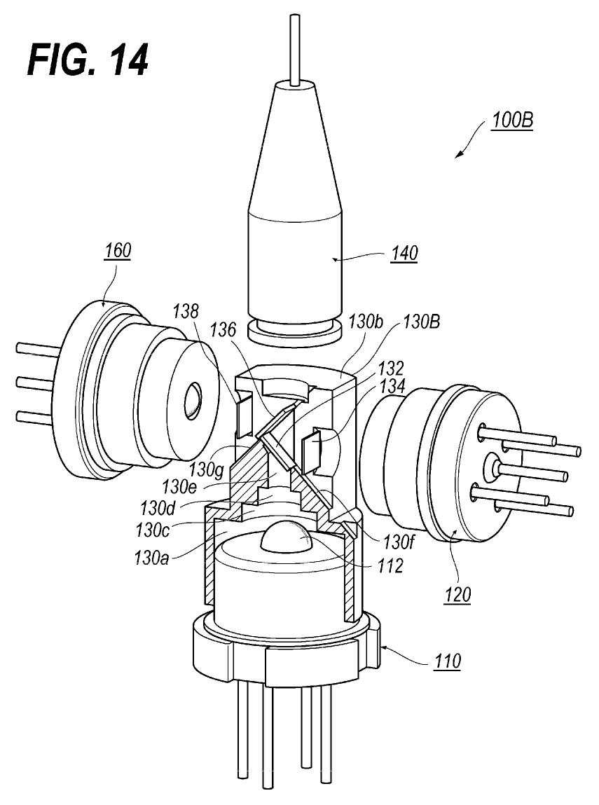

### DESCRIPTION OF PREFERRED EMBODIMENTS

Next, preferred embodiments according to the present invention will be described as referring to accompanying drawings. In the description of the drawings, the same elements will be referred by the same numerals or the same symbols without overlapping explanations.

### First Embodiment

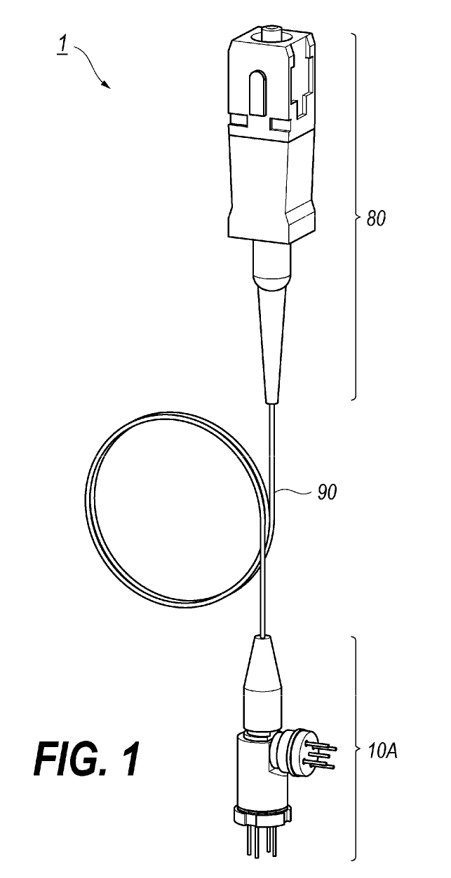

FIG. 1 is a perspective view of a bi-directional optical apparatus including an optical device according to the first embodiment of the invention. The bi-directional optical apparatus 1 shown in FIG. 1 comprises an optical module 10A, an optical connector 80 and an optical fiber 90 connecting the optical module 10A to the optical connector 80. The bi-directional optical apparatus shown in FIG. 1 may be applicable to, for instance, the optical line terminal (OLT) installed in the center station of the PON (Passive Optical Network) system which is a type of the FTTH (Fiber To The Home) system.

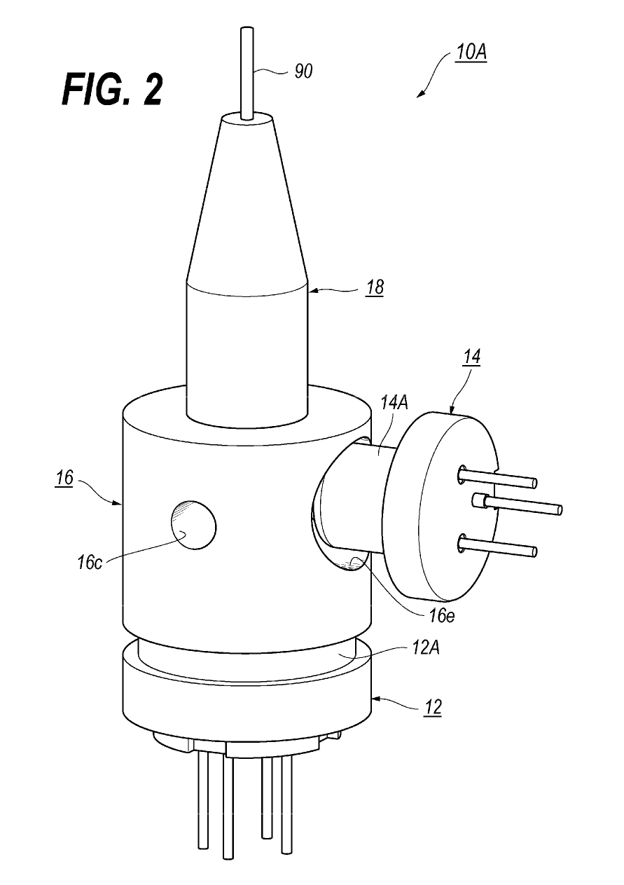

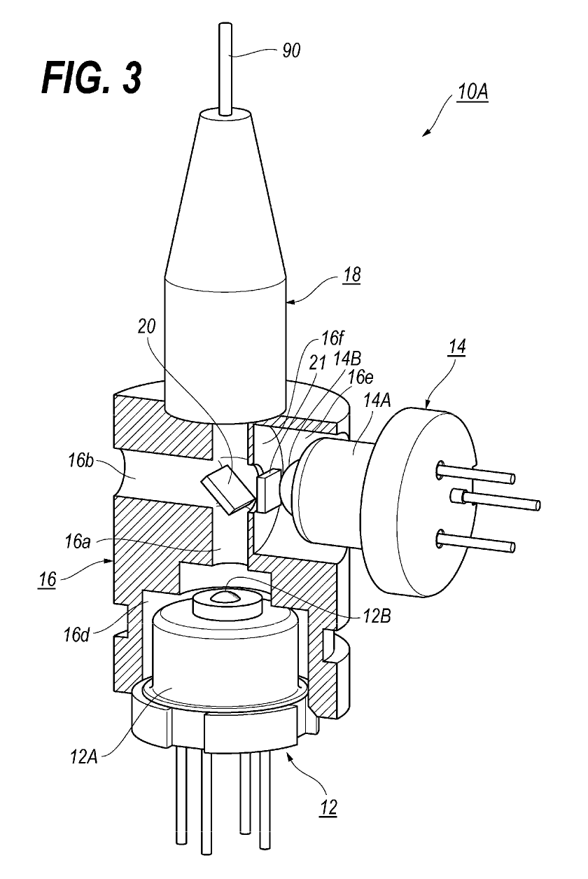

FIG. 2 is an appearance of the optical module 10A; while, FIG. 3 is a partially broken view showing the filter unit 16. Referring to FIGS. 2 and 3, the optical module 10A according to the present embodiment comprises the first optical device 12, the second optical device 14, the filter unit 16, and the coupling unit 18.

The first optical device 12 is a type of an optical transmitting device in the present embodiment and installs a light-emitting device such as semiconductor laser diode. The first optical device 12 emits light with the first wavelength, for instance, 1.31 μm, and provides a co-axial package 12A with a lens 12B on the optical axis thereof. The first optical device 12 is assembled with the filter unit 16.

The second optical device 14 is a type of the light-receiving device in the present embodiment and installs a light-receiving semiconductor device such as photodiode therein. The second optical device 14 receives light with the second wavelength, typically 1.48 μm or 1.55 μm, which is provided from the coupling unit 18, and has a co-axial package 14A with a lens 14B on the optical axis thereof. The second optical device 14 is also assembled with the filter unit 16.

The filter unit 16 is metal cylindrical member for coupling the first optical device 12 and the second optical device 14 with the optical fiber 90 installed in the coupling unit 18. That is, the coupling unit 18 is attached to the one end of the filter unit 16, while, the first optical device 12 is attached to the other end thereof. The second optical device 14 is fixed to the side wall of the filter unit 16. Thus, the second optical device 14 has an optical axis perpendicular to the optical axis connecting the first optical device 12 with the optical fiber 90.

Within the filter unit 16 is installed with the wavelength division multiplexing (hereafter denoted as WDM) filter 20 and the wavelength cut filter 21. The WDM filter 20 may be the first multiplexing filter that transmits light with the first wavelength to couple the optical device 12 with the optical fiber 90 in the coupling unit 18 optically, while, it reflects the light with the second wavelength to couple the second optical device 14 with the optical fiber 90 optically. The wavelength cut filter cuts the light with the first wavelength while transmits the light with the second wavelength.

Next, an arrangement within the filter unit 16 will be described specifically. The filter unit 16 provides the first bore 16a, the second bore 16b, and the third bore 16c for the filter. Referring to FIG. 3, the first bore 16a extends along the axis of the cylinder of the filter unit 16 and has a substantially circular shape. One end of the first bore 16a is attached with the coupling unit 18, while, the other end is fixed with the first optical device 12. The first bore 16a provides a portion 16d with an expanded diameter close to the other end within which the first optical device 12 is inserted. Thus, the first optical device 12 is assembled within the portion 16d of the filter unit 16 such that the lens 12B is set in the center of the first bore 16a.

The second bore 16b also has a cylindrical cross section extending along the direction perpendicular to the cylindrical axis of the filter unit 16 so as to cross the first bore 16a. One end of the second bore 16b is provided with the second optical device 14, that is, the second bore 16b also has a portion 16e with an expanded diameter in the end thereof, and the second optical device 14 is set in this portion 16e such that the lens 14B thereof locates in the center of the second bore 16b. The second bore 16b also provides the cut filter 21 so as to cap the second bore 16b. That is, the cut filter 21 is attached to the step formed by the portion 16e with the expanded diameter with an adhesive.

Referring to FIG. 2, the third bore 16c is a through hole extending to a direction perpendicular to the first bore 16a and also to the second bore 16b. The third bore may be only a hole not passing the filter unit 16. The third bore 16c reaches a position where the first bore 16a crosses with the second bore 16b.

The third bore 16c has a cross section with a circular shape and the inner surface on which the WDM filter 20 is attached. Specifically, the WDM filter 20 is fixed in the position where the three bores, 16a to 16c, cross to each other, such that the surface of the WDM filter 20, which is the reflecting surface, makes a preset angle of, for instance, 45° with respect to optical axes for the light with the first wavelength and for the other light with the second wavelength.

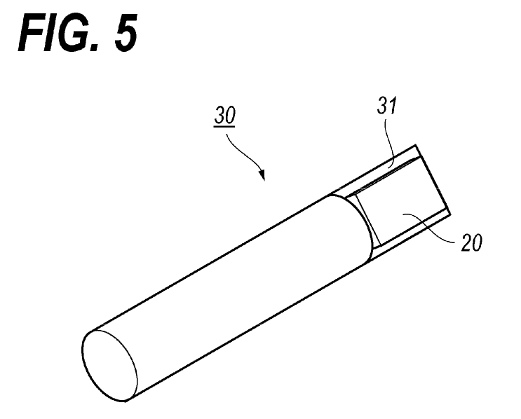

Next, a method to assembly the optical module 10A described above will be explained. First, the filter unit 16 may be prepared by drilling a cylindrical member for the first to third bores. Second, the WDM filter 20 is set in the third bore 16c of the filter unit 16. FIG. 5 illustrates an example of a tool 30 for setting the WDM filter 20 within the third bore 16c. The tool 30 is a pillar member with a diameter slightly smaller than the diameter of the third bore 16c. The end portion 31 of the tool is 31 cut in flat to mount the WDM filter 20 thereon.

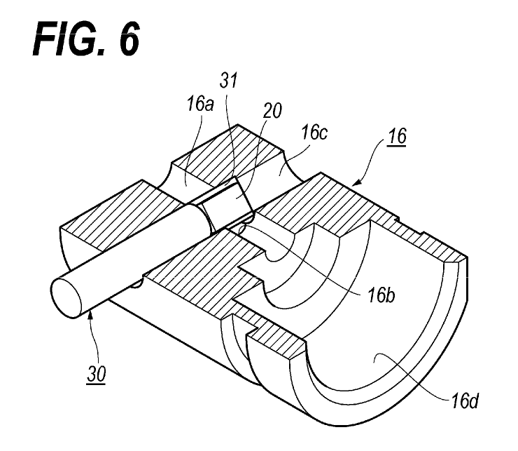

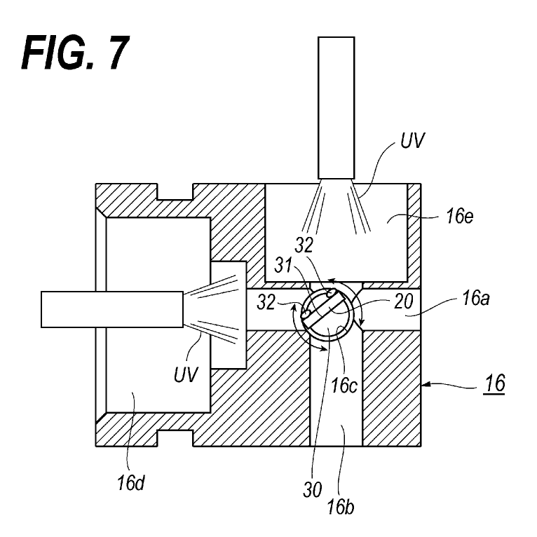

FIG. 6 illustrates a process to set the WDM filter 20 in the preset position within the third bore 16c by using the specific tool 30, and FIG. 7 is a cross section of a plane containing the axis of the first bore 16 and that of the second bore and perpendicular to the third bore 16c, which shows a process to adjust the position and the angle of the WDM filter 20. The WDM filter, as previously described, is placed on the flat portion 31 of the tool after preparing adhesive on positions to be come in contact with the inner surface of the third bore 16c.

As shown in FIG. 6, inserting the tool 30 within the third bore 16c and rotating the tool 30, the WDM filter is set in the preset position with keeping the angle thereof in the preset angle. Because the third bore has the circular cross section, at least both edges of the WDM filter 30 always come in contact with the inner surface of the third bore 16c even the tool is rotated to adjust the angle with respect to two axes. Setting the WDM filter 20 in the preset position and in the preset angle, the adhesive on the WDM filter is cured by irradiating the adhesive with ultraviolet rays through the expanded portion 16d of the first bore 16a and through the expanded portion 16e of the second bore 16b.

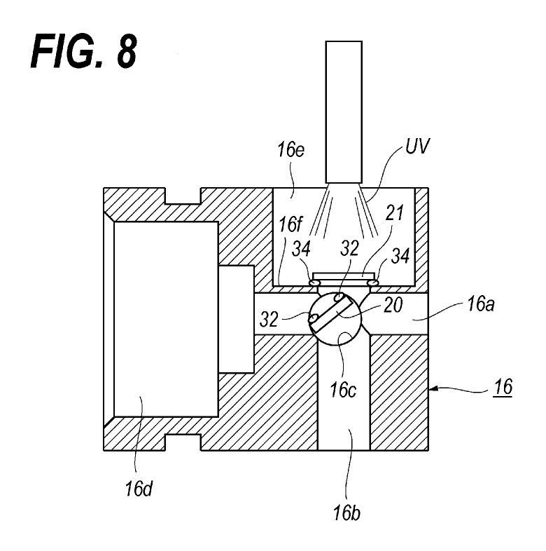

Subsequently, the cut filter 21 is set with an adhesive on the step 16f between the expanded portion 16d and the second bore 16b, which is the bottom of the expanded bore 16d, so as to cap the second bore 16b, as illustrated in FIG. 8. Specifically, preparing the adhesive 34 on a periphery of the cut filter 21 and setting it in the position so as to cap the second bore 16b, the ultraviolet rays is irradiated from the expanded bore 16e to cure the adhesive. Finally, two optical devices, 12 and 14, and the coupling unit 18 are assembled with the filter unit 16 to complete the optical module 10A.

In the optical module 10A, thus described, the filter unit 16 provides the third bore 16c in addition to the first and second bores, 12 and 14, where these two bores, 16a and 16b, are for the optical devices, 12 and 14. The third bore 16c is easily processed by, for instance, drilling the metal pillared member. Moreover, the inner surface of the bore 16c has the constant curvature; accordingly, the preset angle of the WDM filter 20 may be easily and precisely determined with respect to the light incoming thereto and the light outgoing therefrom by rotating the tool shown in FIG. 5 in the bore 16c. Thus, the arrangement of the filter unit 16, in particular, the arrangement of the WDM filter 16 with the first and second optical devices, 12 and 14, may make it possible to assemble the WDM filter 20 easily and precisely.

Although the embodiment shown in the figures circular bore, the shape of the third bore 16c is not restricted to the circular shape. The third bore 16c may provide at least a portion with a preset curvature to install the WDM filter 20. Various cross sections may be applicable to the present invention.

### Second Embodiment

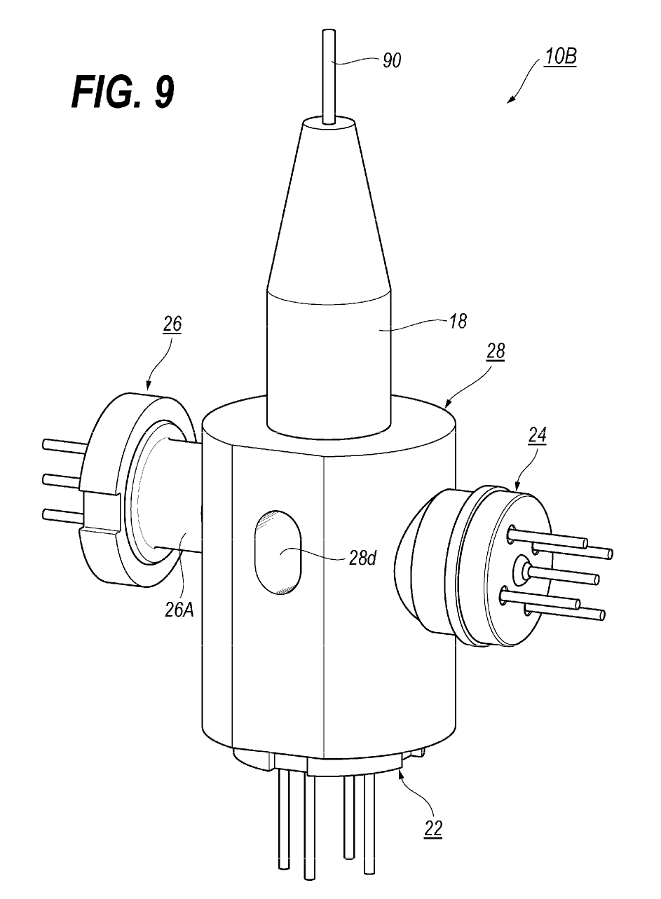

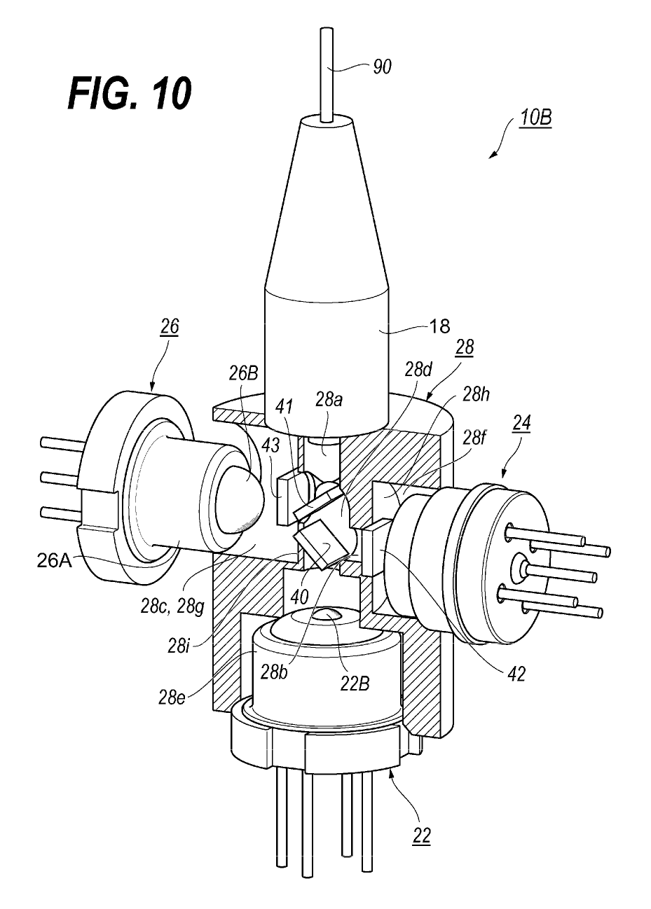

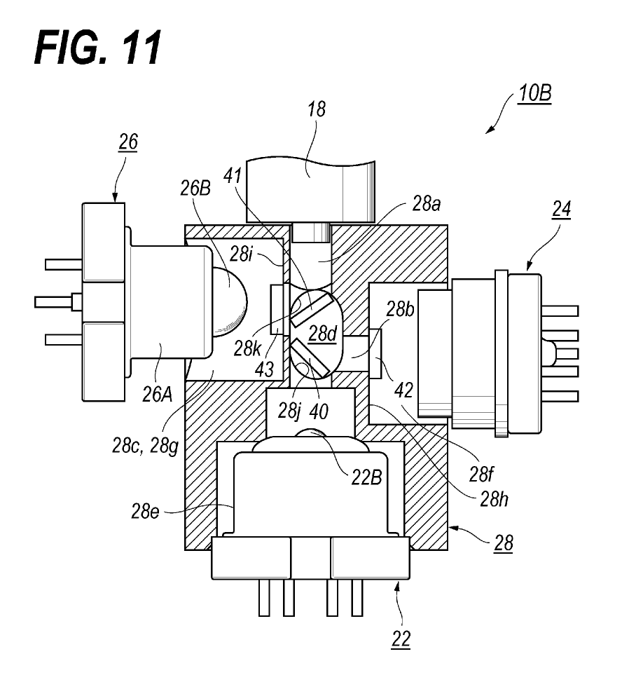

Next, another embodiment according to the present invention will be described. FIG. 9 is a perspective drawing of an optical module 10B according to the second embodiment; FIG. 10 is a partially broken perspective drawing of the filter unit 28; and FIG. 11 is a side cross section of the optical module 10B. Referring to FIGS. 9 to 11, the optical module 10B comprises the first to third optical devices, 22, 24 and 26, the filter unit 28, and the coupling unit 18. The first and second optical devices have the arrangement same as those, 12 and 14, provided in the first optical module 10A.

The third optical device 26 is also a type of the light-receiving device that installs a semiconductor light-receiving device such as photodiode. The third optical device 26 receives light with the third wavelength, for instance, 1.48 μm or 1.55 μm, different from the second wavelength the second optical device receives. The light with the third wavelength is provided from the optical fiber 90 in the coupling unit 18. The third optical device 26 also has a co-axial package 26A with a lens 26B on the optical axis thereof.

The filter unit 28, which is also a metal pillared member, assembles the coupling unit 18 and the first to third optical devices, 22 to 26, to couple the optical fiber 90 in the coupling unit 16 optically with respective devices, 22 to 26. The coupling unit 16 is attached to one end of the filter unit 28; while, the first optical device 22 is set in the other end of the unit 28. The second and third optical devices, 24 and 26, are each attached to the side walls of the filter unit 28 opposite to each other such that the axes of two optical devices, 24 and 26, are perpendicular to the axis connecting the coupling unit 18 with the first optical device 22.

In the filter unit 28 is installed with two WDM filters, 40 and 41, and two cut filters, 42 and 43. The first WDM filter 40 is a type of the wavelength division multiplexing filter, which transmits light with the first wavelength to couple the first optical device 22 optically with the fiber 90 in the coupling unit 18, while, it reflects light with the second wavelength to couple the second optical device 24 optically with the optical fiber 90. The cut filter 42 cuts the light with the first wavelength and transmits the light with the second wavelength. The arrangement of the first WDM filter 40, the first and second optical devices, 22 and 24, and the cut filter 42 are the same as those installed in the optical module 10A of the first embodiment.

The second WDM filter 41 transmits the light with the first and second wavelengths to couple the first and second optical devices, 22 and 24, optically with the optical fiber 90, but reflects the light with the third wavelength to couple the third optical device 26 optically with the optical fiber 90. The cut filter 43 cuts the light with the first and second wavelengths, while, it transmits the light with the third wavelength.

The arrangement in the filter unit 28 will be further described in detail. The filter unit 28 provides first to third bores, 28a to 28c and the filter bore 28d. The first bore 28a is a via hole with a circular cross section extending along the axis of the pillared filter unit 28. One end of the first bore 28a attaches the optical fiber 90 in the coupling unit 18, while, the other end provides a portion 28e whose diameter is expanded in which the first optical device 22 is set. Specifically, the first optical device 22 is set in the expanded bore such that the lens 22B is aligned with the axis of the first bore 28a.

The second and third bores, 28b and 28c, are via holes with a circular cross section extending along the direction perpendicular to the axis of the pillared filter unit 28. The second bore 28b crosses the first bore 28c at a position in the filter unit 28, and the third bore 28c also crosses the first bore at another position different from the position where the first and second bores, 28a and 28b, cross. The second bore 28b is in parallel with the third bore 28c in the present embodiment.

One end of the second bore 28b sets the second optical device 24 thereto, while, one end of the third bore 28c assembles the third optical device 26 therewith. Specifically, the second bore 28b provides in the end thereof a portion 28f with an expanded diameter, into which the second optical device 24 is set in. Similarly, one end of the third bore 28c provides a portion 28g with an expanded diameter in which the third optical device 26 is inserted.

The cut filter 42 is set with an adhesive on a step 28h formed between the second bore 28b and the expanded bore 28f so as to cover the second bore 28b. Similarly, the other cut filter 43 is set with an adhesive on the step 28i between the third bore 28c and the expanded portion 28i.

The filter bore 28d is a via hole extending along a direction perpendicular to the first to third bores, 28b to 28c, and unnecessary to pass through the filter unit 28. The filter bore 28d passes at least a point where the first and second bores cross, and another point where the first and third bores cross. Thus, the filter bore is connected with the first to third bores, 28a to 28c.

Further, the filter bore 28d provides an inner wall with a preset curvature along the axis thereof. For instance, the filter bore 28d of the present embodiment has a cross section with a prolonged circular whose longer axis is in parallel to the axis of the first bore 28a. Specifically, the filter bore 28d comprises two inner walls, 28j and 28k, with the semi-circular shape facing to each other along the axis of the first bore 28a, and two plane walls each connecting the semi-circular walls. One of semi-circular walls 28j mounts the first WDM filter 40, while, the other semi-circular wall 28k mounts the second WDM filter 41, which are illustrated in FIG. 11.

The first WDM filter 40 is positioned at a point where the first and second bores, 28a and 28b, cross in the filter unit so as to make an angle, 45° in the present embodiment, with respect to the optical axis for the light with the first wavelength and the other optical axis for the light with the second wavelength. The second WDM filter 41 is set at a point where the first and third bores, 28a and 28c, cross in the filter unit 28 such that the reflecting surface thereof makes a preset angle, also 45° in the present embodiment, with respect to the light with the first wavelength and the light with the third wavelength.

The process for manufacturing the optical module 10B may be similar to those for the module 10A of the first embodiment. That is, the filter unit 28 may be prepared by drilling a pillared metal member for the first to third bores, 28a to 28c, and for the filter bore 28d. The tool such as shown in FIG. 5 may set two WDM filters, 40 and 41, in respective preset positions as adjusting the angles thereof. After setting the cut filters, 42 and 43, in respective positions, the first to third optical devices, and the coupling unit 18 are assembled with the filter unit 18 to complete the optical module 10B of the present embodiment.

The optical module 10B provides the filter unit 28 that provides filter bore 28d in addition to the first to third bores, 28a to 29c. This filter bore 28d has the inner walls, 28j and 28k, with the preset curvature intersecting the axis of the filter unit 28. Such a bore may be easily processed by, for instance, drilling the pillared metal member. The WDM filters, each attached to respective inner walls with the curvature, may be easily and precisely adjusted in the angle thereof with respect to the optical axes for the incoming light and for the outgoing light by rotating the WDM filter, 40 or 41, as coming two edges thereof in contact with the inner wall. Thus, the optical module 10B of the present embodiment, even when the module provides three optical devices, two of which have the axis in perpendicular to the axis of the rest optical device, has a convenient arrangement for two WDM filters.

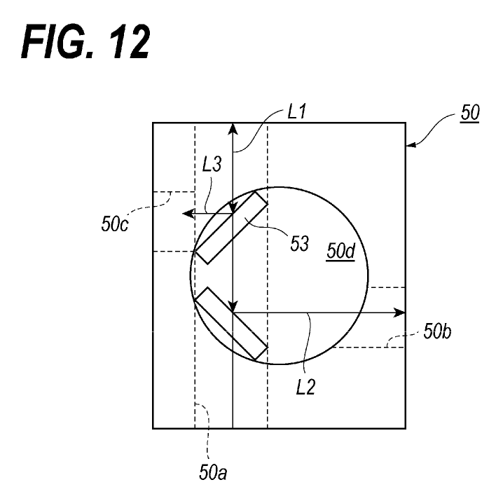

FIG. 12 shows a modification of the filter bore according to the second embodiment, in which the filter bore 50d has a circular cross section to install two WDM filters. The first WDM filter 52 is set at a preset point of the circular inner wall, that is, the point where the first and second bores, 50a and 50b, intersect to each other; while, the second WDM filter 53 has set at another preset point of the inner wall, that is, the point where the first and third bores, 50a and 50c, intersect to each other. Although FIG. 12 seems that the third bore 50c does not reach the first bore 50a, the third bore 50c substantially crosses the first bore 50a because the end of the third bore 50c is common with the filter bore 50d.

In FIG. 12, the diameter of the filter bore 50d is larger than that of the first to third bores, 50a to 50c, such that, firstly, the filter bore 50d covers two critical points, one of which the first and second bores intersect, while the other of which the first and third bores intersect, and second, the center of the filter bore 50d should be apart from the center of the first bore 50a by a distance. Thus, two WDM filters, 52 and 53, may be adjusted so as to make the primary surface thereof the preset angle, 45°, with respect to the optical axes, L1 to L3, for the light with the first and third wavelengths.

While particular embodiments of the present invention have been described herein for purposes of illustration, many modifications and changes will become apparent to those skilled in the art. For instance, although the embodiments above described concentrate on arrangements where the optical module provides one or two WDM filters, the module may provide more WDM filters and the filter unit prepares more filter bores depending on the count of the WDM filter. Also, the embodiments provide the filter unit with a pillared metal member, but the filter unit may be a rectangular block made of metal, resin or other materials. The first to third optical devices may be the optical transmitting module or the optical receiving module, not restricted to the combination of the types described above. Accordingly, the appended claims are intended to encompass all such modifications and changes as fall within the true spirit and scope of this invention.

We claim:

1. A bi-directional optical module that processes first and second optical signals each having first and second wavelengths different from each other, respectively, with respect to a single fiber, said bi-directional module comprising:
at least first and second optical devices, said first optical device processing said first optical signal and said second optical device processing said second optical signal;
a first WDM filter for transmitting said first optical signal and reflecting said second optical signal;
a filter unit for installing said WDM filter, said filter unit providing a filter bore having an inner wall portion of a curved shape with a preset curvature,
wherein said first WDM filter comes in contact with said inner wall portion of said filter bore by two edges thereof.

2. The bi-directional optical module of claim 1,
wherein said filter unit provides a first bore to pass said first optical signal and a second bore to pass said second optical signal, said second bore crossing said first bore,
wherein said filter bore crosses a point where said second bore crosses said first bore.

3. The bi-directional optical module of claim 2,
wherein said first bore and said second bore make a substantially right angle, and said filter bore makes a substantially right angle with respect to each of said first bore and said second bore.

4. The bi-directional optical module of claim 2,
wherein said first and second optical devices each has a co-axial package, and
wherein said first bore provides a portion whose diameter is expanded to assemble said first optical device therein, and said second bore provides a portion whose diameter is expanded to assemble said second optical device therein.

5. The bi-directional optical module of claim 4,
further providing a cut filter to cut said first optical signal and to transmit said second optical signal,
wherein said cut-filter is set in a step formed between said second bore and said portion of said second bore whose diameter is expanded.

6. The bi-directional optical module of claim 1,
wherein said filter bore has a circular cross section.

7. The bi-directional optical module of claim 1,
wherein said filter bore has an expanded circular cross section with two semi-circular portions facing to each other and two straight edges each connecting said semi-circular portions.

8. The bi-directional optical module of claim 1,
wherein said first optical device is a light-emitting device to emit said first optical signal to said optical fiber, and said second optical device is a light-receiving device to receive said second optical signal.

9. The bi-directional optical module of claim 1,
further comprising a third optical device for processing a third optical signal and a second WDM filter set in said filter bore,
wherein said filter unit provides a third bore to pass said third optical signal,
wherein said filter bore provides another inner wall portion of a curved shape with a preset curvature, said second WDM filter coming in contact with said another inner wall portion by at least two edges thereof, and
wherein said second WDM filter transmits said first and second optical signals and reflects said third optical signal.

10. The bi-directional optical module of claim 9,
wherein said third bore crosses said first bore in a substantially right angle, and said filter bore crosses a point where said third bore crosses said first bore.

11. The bi-directional optical module of claim 9,
wherein said filter bore has an expanded circular shape with two semicircular portions and two straight portions each connecting said semicircular portions,
wherein said first WDM filter comes in contact with said one of two semicircular portions and said second WDM filter comes in contact with said other of two semicircular portions.

12. The bi-directional optical module of claim 9,
wherein said third optical device has a co-axial package, and
wherein said third bore provides a portion whose diameter is expanded to set said third optical device therein.

13. The bi-directional optical module of claim 12,
further comprising a second cut filter to reflect said first and second optical signals and to transmit said third optical signal,
wherein said second cut filter is set on a step formed between said third bore and said portion with expanded diameter.

14. The bi-directional optical module of claim 9,
wherein said first optical device is a light-emitting device to emit said first optical signal to said optical fiber, and said second and third optical devices are light-emitting devices to receive said second and third optical signals, respectively.

15. The bi-directional optical module of claim 9,
wherein said first to third optical signals have a wavelength in 1.3 μm band, that in 1.48 μm band and that in 1.55 μm band, respectively.

16. The bi-directional optical module of claim 1,
wherein said filter unit is made of metal.

17. A method to assemble a bi-directional optical module comprising at least two optical devices and a filter unit that installs at least one WDM filter, said method comprising steps of:
forming first and second bores in said filter unit for said first and second optical devices, respectively, said first bore passing a first optical signal processed by said first optical device, said second bore passing a second optical signal processed by said second optical device, said first bore crossing said second bore in substantially right angle;
forming a filter bore with an inner wall portion with a curvature, said filter bore crossing a point in substantially right angle where said first bore crosses said second bore;
adjusting an angle of said WDM filter within said filter bore as abutting said WDM filter against said inner wall portion by at least two edges thereof; and
fixing said WDM filter to said inner wall portion by irradiating an adhesive provided on said at least two edge of said WDM filter with ultraviolet rays from at least one of said first and second bores.

18. The method of claim 17,
wherein said step to form said filter bore includes a step of drilling said filter unit.

19. The method of claim 17,
wherein said step to form said first and second bores include steps of drilling said filter unit.
